(19) United States
(12) Patent Application Publication
(10) Pub. No.: US 2008/0081228 A1
(43) Pub. Date: Apr. 3, 2008

(54) Anode purge gas dilution

(76) Inventors: Neil B. Fagan, Vancouver (CA); John D. Usborne, Vancouver (CA); David A. Leboe, Vancouver (CA); Jeremy S. Lindstrom, Vancouver (CA); Kenneth W. Kratschmar, Vancouver (CA)

Correspondence Address: TROP PRUNER & HU, PC, 1616 S. VOSS ROAD, SUITE 750, HOUSTON, TX, 77057-2631, US

(21) Appl. No.: 11/820,725

(22) Filed: Jun. 20, 2007

Related U.S. Application Data
(60) Provisional application No. 60/805,294, filed on Jun. 20, 2006.

(51) Int. Cl. H01M 8/00

(52) U.S. Cl. 429/13; 429/22

(57) ABSTRACT

A system includes a fuel cell that has an anode chamber that is in a deadheaded configuration. A controller of the system controls a valve that is connected to the anode chamber pursuant to a modulation scheme to purge the anode chamber.

This application claims the benefit under 35 U.S.C. § 119(e) to U.S. Provisional Patent Application Ser. No. 60/805,294, entitled, “ANODE PURGE GAS DILUTION,” which was filed on Jun. 20, 2006, and is hereby incorporated by reference in its entirety.

### BACKGROUND

The invention generally relates to anode purge gas dilution.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange membrane (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C) to 75° temperature range. Another type of PEM fuel cell may employ a phosphoric-acid-based polybenziamidazole (PBI) membrane that operates in the 150° to 2000 temperature range.

At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Catalyzed electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

A fuel cell stack may be arranged in an arrangement called a “dead-ended,” or “deadheaded,” configuration. In the dead-headed configuration, the anode chamber of the fuel cell stack does not have a continuous anode exhaust flow. Instead, incoming anode fuel accumulates in the anode gas chamber and promotes electrochemical reactions inside the fuel cell stack. Due to the lack of a continuous anode exhaust, inert gases may build up inside the anode chamber and decrease performance of the fuel cell stack. Therefore, a typical fuel cell system with a deadheaded fuel cell stack may intermittently purge the inert gases from the anode chamber by flushing the anode chamber with hydrogen, for example. For this purpose, the fuel cell system may contain a purge valve that is normally closed to seal off the exhaust port of the anode chamber, and is opened during the purging of the chamber.

### SUMMARY

In an embodiment of the invention, a system includes a fuel cell that has an anode chamber that is in a deadheaded configuration. A controller of the system controls a valve that is connected to the anode chamber, pursuant to a modulation scheme to purge the anode chamber.

In another embodiment of the invention, a system includes a fuel cell and a vessel. The fuel cell has an anode chamber that is in a deadheaded configuration. The vessel is downstream of the anode chamber to temporarily store a purge flow from the anode chamber and provide an exhaust flow to rid the vessel of the stored purge flow. The purge flow is stored in the vessel at a first rate that is substantially larger than a rate at which the purge flow leaves the vessel.

In yet another embodiment of the invention, a system includes a fuel cell, a mixer and a dilution source. The fuel cell has an anode chamber that is in a deadheaded configuration and is adapted to provide a cathode exhaust flow. The mixer dilutes a purge flow from the anode chamber with the cathode exhaust flow to provide a diluted flow. The dilution source further dilutes the diluted flow.

Advantages and other features of the invention will become apparent from the following drawing, description and claims.

### BRIEF DESCRIPTION OF THE DRAWING

FIG. 1 is a schematic diagram of a system according to an embodiment of the invention.

FIGS. 2, 5, 6A, 6B, 7 and 9 are schematic diagrams of embodiments of anode purge subsystems according to different embodiments of the invention.

FIGS. 3, 8 and 10 are flow diagrams depicting techniques to dilute an anode purge gas flow according to different embodiments of the invention.

FIG. 4 is an illustration of a control signal used to control a valve of the anode purge subsystem of FIG. 2 according to an embodiment of the invention.

### DETAILED DESCRIPTION

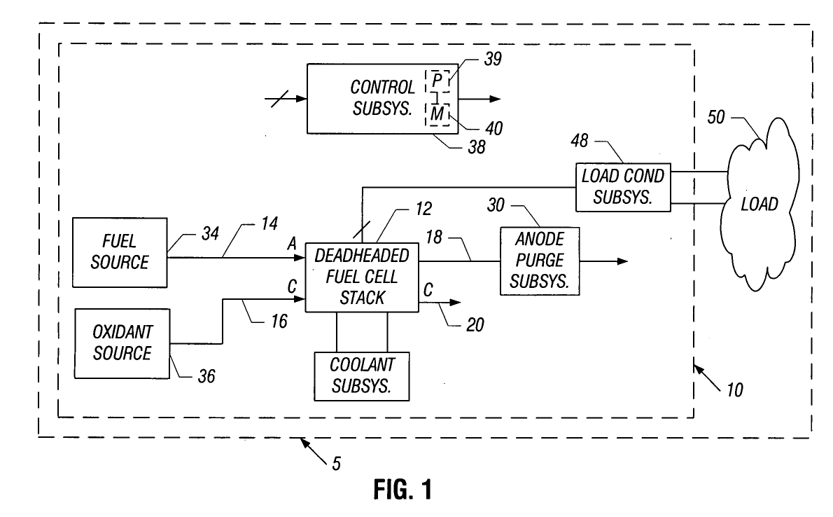

Referring to FIG. 1, an embodiment 10 of a system in accordance with the invention includes a fuel cell stack 12 that has an anode chamber that is arranged in a deadheaded configuration. In this regard, the anode chamber receives an incoming fuel flow at an anode inlet 14 from a fuel source 34. However, the anode chamber, in general, does not have a continuous anode exhaust port. Instead, ideally, the fuel remains in the anode chamber and is consumed by the electrochemical reactions inside of the fuel cell stack 12. Because impurities tend to accumulate in the closed anode chamber, the fuel cell stack 12 is connected to an anode purge subsystem 30, which as described herein intermittently establishes an exhaust, or purge, path for the anode chamber. Thus, when the anode purge subsystem 30 establishes the momentary purge path, fuel (hydrogen, for example) and other impurities (inert gases such as Nitrogen, for example) flow out of the anode chamber, as described below.

For safety, environmental and possibly other concerns, it is typically desired for the purge flow to have a sufficiently small concentration of fuel (hydrogen, for example). Various embodiments of the anode purge system 30 are described herein for purposes of diluting the anode purge flow.

The fuel cell stack 12 also includes a cathode inlet 16, which receives an incoming oxidant flow from an oxidant source 36 (an air blower or compressor, as examples). The incoming oxidant flow is communicated through the cathode chamber of the fuel cell stack 12 for purposes of promoting the electrochemical reactions inside the stack 12. The cathode exhaust exits the fuel cell stack 12 at a cathode exhaust outlet 20. It is noted that the system 10 may combust the cathode exhaust flow and/or anode purge flow; route part of the anode purge flow/cathode exhaust flow back through the fuel cell stack 12; vent the anode purge flow/cathode exhaust flow; etc., depending on the particular embodiment of the invention.

Among its other features, the system 10 may includes a load conditioning subsystem 48, which is electrically connected to the fuel cell stack 12 to receive power from the stack. The load conditioning subsystem 48 transforms the power that is generated by the fuel cell stack 12 into the appropriate form for an external load 50. Depending on the particular embodiment of the invention, the load 50 may be an AC or a DC load. The system 10 may also include such features as a coolant subsystem 22, which circulates a coolant through the fuel cell stack 12 for purposes of regulating the temperature of the stack 12.

The system 10 may include a control subsystem 38 for purposes of controlling such components as valves, motors, electrical switches, etc. of the system 10 as well as receiving input conditions and communications from other components of the system 10, such as communications related to the health of the fuel cell stack, oxygen and fuel sensors, etc., depending on the particular embodiment of the invention. The control subsystem 38, in general, includes one or more microprocessors and/or microcontrollers, which are collectively represented in FIG. 1 by a processor 39. The processor 39, in general, may execute instructions that are stored in a memory 40 of the control subsystem 38. It is noted that the memory 40 may be distributed among several components, may be part of an integrated memory, etc., depending on the particular embodiment of the invention.

In accordance with some embodiments of the invention, the system 10 and load 50 may be portable, or mobile, and more particularly may be (as an example) part of a motor vehicle 5 (a car, truck, airplane, etc.). Thus, the system 10 may serve as at least part of the power plant (represented by the load 50) of the vehicle. In other embodiments of the invention, the system 10 and load 50 may be part of a stationary system. For example, the system 10 may supply all or part of the power needs of a house, electrical substation, backup power system, etc. Additionally, the system 10 may supply thermal energy to a thermal energy consuming load (water heater, water tank, heat exchanger, etc.), and thus, electrical as well as thermal loads to the system are also envisioned. Therefore, many different applications of the system and loads that consume energy from the system are contemplated and are within the scope of the appended claims.

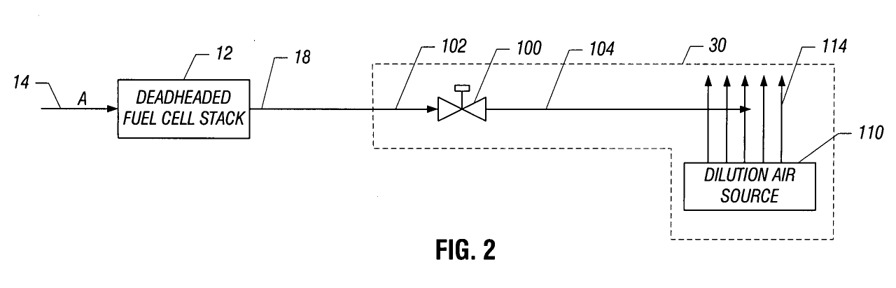

Referring to FIG. 2, in accordance with some embodiments of the invention, the anode purge subsystem 30 includes a purge valve 100 (a solenoid valve, for example), which has its inlet 102 connected to a purge outlet 18 of the fuel cell stack's anode chamber. In general, the purge valve 100 may be intermittently opened for purposes of purging the anode chamber of the fuel cell stack 12. The purge valve 100 is otherwise closed.

More specifically, it is possible to purge the anode chamber with a single burst from the purge valve such that an exhaust from the purge valve 100 is mixed with a dilution air flow 114 (provided by a dilution air source 110) to ensure that the concentration of the hydrogen leaving the product is less than 50 percent LFL (20,000 parts per million (ppm)). This approach requires a relatively high rate of the dilution air flow 114 due to the high and restricted flow and the instantaneous volume of hydrogen to be diluted. Due to the high dependence on the dilution air flow, some form of feedback (a flow indicator or hydrogen sensor, as examples) may be used to ensure that the dilution air is above a required level.

Instead of the above-described approach, however, the purge valve 100 may be controlled differently so that the volume of released purge gas is approximately the same each time the purge valve 100 is opened. In this regard, the purge valve 100 may be operated to purge the anode chamber in multiple discrete volumes over an extended period of time. More specifically, in accordance with some embodiments of the invention, the purge valve 100 is controlled pursuant to a modulation scheme, such as a pulse width modulation (PWM) scheme, in which a control subsystem (see FIG. 1) operates the purge valve 100 in a pulsed fashion pursuant to consecutive (in time) switching cycles 150 (see FIG. 4). Each switching cycle 150 has an on time 152 in which the purge valve 100 is open and an off time 154 in which the purge valve 100 is closed. The duty cycle (i.e., the ratio of the on time 152 to a total cycle time) is controlled for purposes of controlling the average purge flow into the dilution stream, as compared to the above-described case of opening the purge valve 100 for as long as it takes to sufficiently purge the anode chamber.

As a more specific example, when the impurity level inside the anode chamber reaches a predetermined level, the following PWM scheme may be used in accordance with some embodiments of the invention. The on time 152 may be for 0.2 seconds and the off time 154 may be for 0.8 seconds, which establishes a total cycle time of 1.0 second. As an example, ten switching cycles with the above-described duty cycle may be employed to purge a similar volume that would be purged if the valve 100 were instead open continuously for 2.0 seconds. The difference is that the dispersion of the purge gas is distributed over an extended period, thereby reducing the need to instantaneously dilute a single large volume of gas.

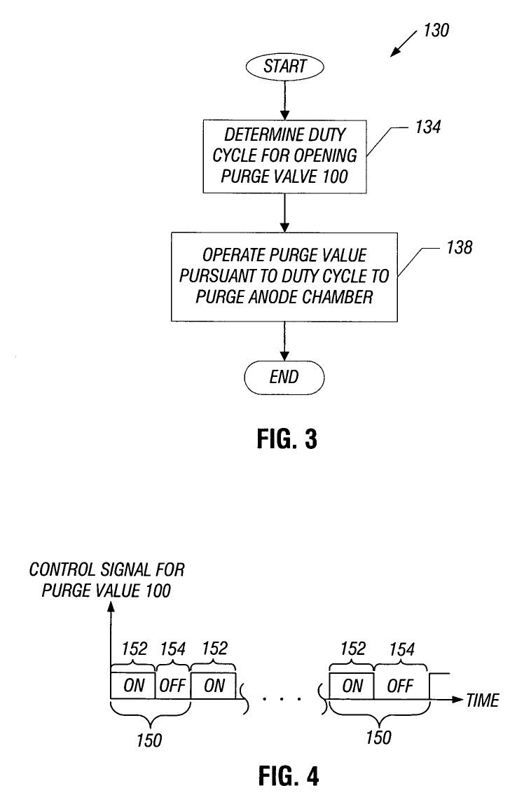

Referring to FIG. 3, to summarize, a technique 130 in accordance with embodiments of the invention includes determining (block 134) a duty cycle for opening the purge valve 100. With this determined duty cycle, the purge valve 100 may then be operated (block 138) pursuant to the duty cycle to purge the anode chamber.

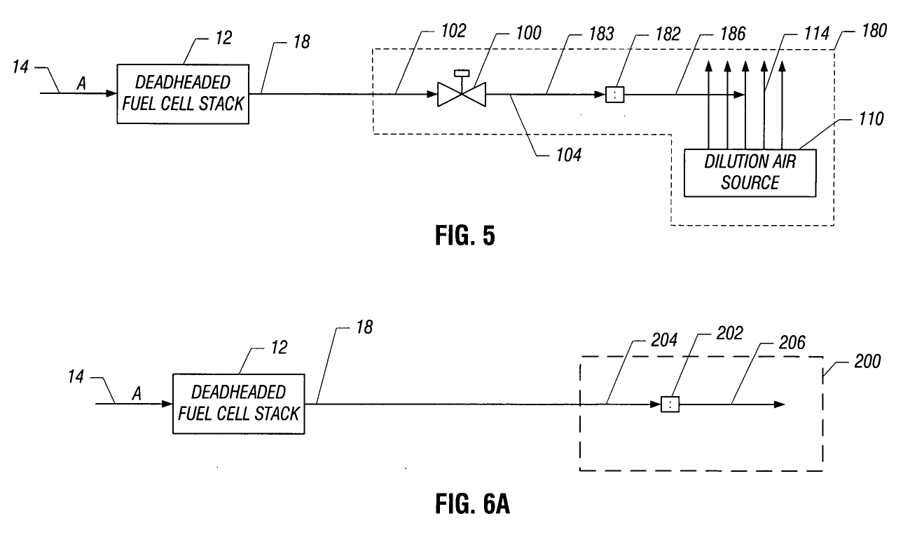

FIG. 5 depicts an alternative anode purge subsystem 180 in accordance with other embodiments of the invention. The anode purge subsystem 180 has a similar design to the anode purge subsystem 30, with like references being used to denote similar components. However, unlike the anode purge subsystem 30, the subsystem 180 includes a flow restrictor 182 that is located downstream of the purge valve 100. In this regard, an inlet 183 of the flow restrictor 182 may be coupled to the outlet 104 of the purge valve 100, and an outlet 186 of the flow restrictor 182 provides an exhaust flow to the air dilution flow 114.

Similar to the anode purge system 30, the objective of the anode purge subsystem 180 is to reduce the instantaneous high flow of purge gas to minimize the requirements for dilution air. In this case, the purge gas flow rate is decreased through the use of the flow restrictor, which may be located anywhere between the outlet 118 and the dilution air flow 114. Thus, the position of the flow restrictor 182 may be located upstream of the purge valve 100 in accordance with other embodiments of the invention. When the purge valve 100 is open, the flow of purge gas is a function of the upstream pressure and the size of the restriction that is imposed by the flow restrictor 182.

Thus, in accordance with some embodiments of the invention, when a purge of the anode chamber is required, the solenoid valve 100 may open and allow a flow, which is defined by the operative pressure and the flow restriction imposed by the flow restrictor 182. When the impurities have been removed from the anode chamber, the purge valve 100 is closed.

In another embodiment of the invention, the purge valve 100 of the anode purge subsystem 30 may be operated by the control subsystem 38 (see FIG. 1) pursuant to a PWM scheme, similar to the one described above. The downstream restriction imposed by the flow restrictor 182 controls the maximum purge flow rate. This arrangement allows for more control of the pulse duration and reduces the discrete volumes of purge gas.

It is noted that an added advantage of the flow restrictor 182 is that should a catastrophic failure of the purge valve 100 occur, the flow restrictor 182 imposes a limit on the overall flow rate out of the fuel cell stack 12. Thus, the flow restrictor 182 may also be considered a safety feature.

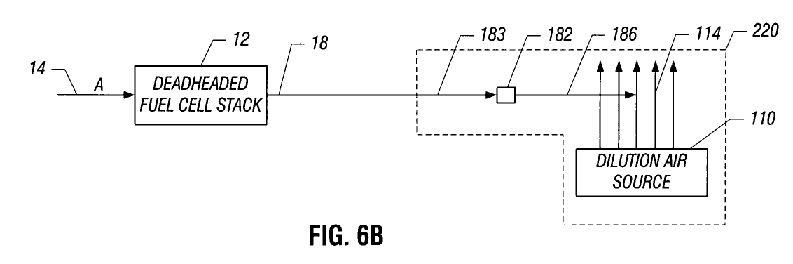

Referring to FIG. 6A, in accordance with another embodiment of the invention, an anode purge subsystem 200 includes only a flow restrictor 202 that bleeds a small portion of the purge gas continuously out of the anode chamber of the fuel cell stack 12. In this regard, the flow restrictor 202 may have an inlet 204 that is connected to the outlet 18, and an outlet 206 of the flow restrictor 202 releases a flow to the surrounding environment, which has a sufficiently low level of hydrogen.

In other embodiments of the invention, the anode purge subsystem may have a constant anode bleed flow, which is further diluted by an air flow. For example, referring to FIG. 6B, in accordance with some embodiments of the invention, an anode purge subsystem 220 may be used. The anode purge subsystem 220 has the same general design as the subsystem 180 of FIG. 5, with common reference numerals being used to denote similar components, except that the subsystem 220 does not include the purge valve 100.

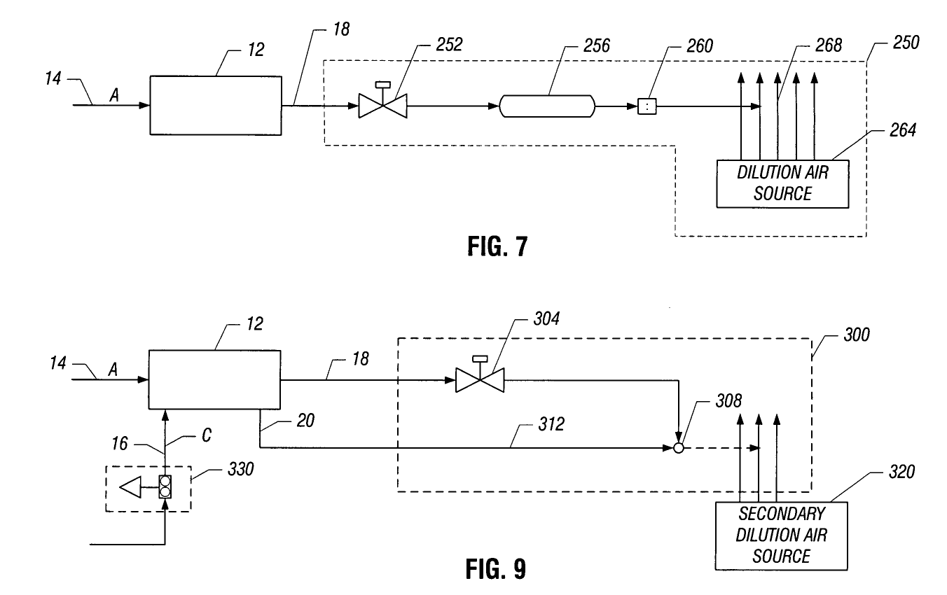

Referring to FIG. 7, in accordance with another embodiment of the invention, an anode purge subsystem 250 includes a vessel 256, which represents a discrete volume to which the anode chamber of the fuel cell stack 12 may be purged. More specifically, in accordance with some embodiments of the invention, communication between the vessel 256 and the anode chamber of the fuel cell stack 12 is controlled by a purge valve 252 (a solenoid valve, for example).

In accordance with some embodiments of the invention, the control subsystem 38 (see FIG. 1) opens the purge valve 252 for a given period of time to transfer all impurities from the anode chamber to the downstream vessel 256. The control subsystem 38 then closes the purge valve 252. A flow restrictor 260 is located downstream of the vessel 256 and is connected to its outlet. The flow restrictor 256 establishes a small purge gas bleed into a dilution air flow 268, which is produced by a dilution air source 264. Thus, the continuous flow rate out of the vessel 256 is significantly less than the flow rate into the vessel 256 when the purge valve 252 is open.

It is noted that the amount of discharge from the anode chamber of the fuel cell stack 12 is a function of the volume of the vessel 256, which stores the purge gas from the anode chamber. If this volume is sized correctly, the volume does not contain sufficient energy to pose a safety hazard. In accordance with some embodiments of the invention, the anode purge subsystem may not include the dilution air source 264, in that the flow is slow enough that no dilution air is required. Thus, many variations are possible and are within the scope of the appended claims.

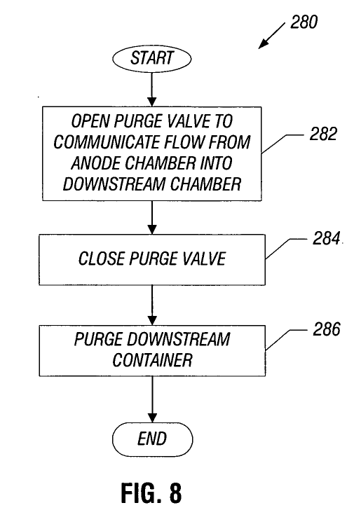

To summarize, FIG. 8 depicts a technique 280 in accordance with some embodiments of the invention. Pursuant to the technique 280, the purge valve is open (block 282) to communicate flow from anode chamber of a fuel cell stack into a downstream container. The purge valve is then closed, pursuant to block 284. Subsequently, the downstream container is purged, pursuant to block 286.

Referring to FIG. 9, in accordance with yet another embodiment of the invention, an anode purge subsystem 300 uses the cathode exhaust flow from the fuel cell stack 12 as the primary dilution air source. In this regard, the anode purge subsystem 300 includes a purge valve 304, which is connected to the outlet 18 to receive the purge flow from the anode chamber of the fuel cell stack 12. When the purge valve 304 is open, the purge gas is communicated to a mixer 308, which is also connected to receive a flow (via a conduit 312) from the cathode exhaust outlet 20 of the fuel cell stack 12. Thus, the cathode exhaust of the fuel cell stack 12 is the first source of dilution of the purge gas. In accordance with some embodiments of the invention, the outlet of the mixer 308 may be provided to provide a flow, which is further diluted by a secondary dilution air source 320.

An advantage of using the cathode exhaust stream as the primary dilution flow is that the flow rate of oxidant is already measured before it enters the fuel cell stack 12, thereby providing a measured flow rate of dilution gas. Also, the fuel cell exhaust has the added benefit of a reduced amount of oxidant, as a large percentage of it is consumed during the fuel cell reaction as well as containing water vapor.

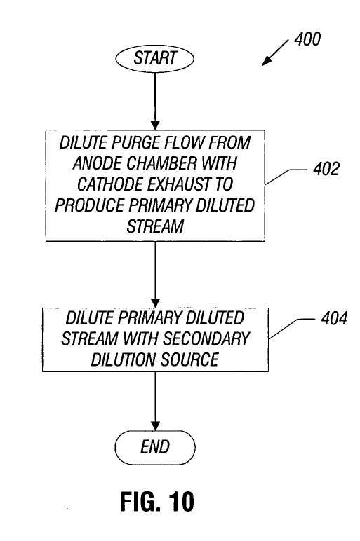

Thus, to summarize, a technique 400, which is depicted in FIG. 10, may be used in accordance with some embodiments of the invention. Pursuant to the technique 400, a purge flow from the anode chamber of a fuel cell stack is diluted (block 402) with cathode exhaust to produce a primary dilution stream. The primary diluted stream is then further diluted (block 404) with a secondary dilution source.

Still referring to FIG. 9, as a more specific example, in accordance with some embodiments of the invention, the control subsystem 38 (see FIG. 1) may first determine that an anode purge is required. The control subsystem 38 then increases the flow of oxidant to the cathode inlet 16 to a higher purge flow rate, than the flow that occurs other than in connection with the purge dilution flow. As an example, the fuel cell system may include an oxidant flow sensor 330, which is disposed between an inlet 340 and the cathode inlet 16 for purposes of determining the amount of oxidant flow to the cathode chamber of the fuel cell stack 12. Next, after the oxidant flow to the fuel cell stack 12 has been increased to the purge flow rate, the control subsystem opens the purge valve 304. At this point, at the mixer 308 the cathode exhaust flow is the primary dilution until the concentration of hydrogen is below a certain level. After the concentration of hydrogen is below this level, the control subsystem 38 then returns the oxidant flow rate to its lower rate in order to satisfy the stoichiometric ratio for reactions inside the fuel cell stack 12.

It is noted that the primary dilution purge flow rate is determined by the size of the oxidant delivery system for the fuel cell stack 12. The purge flow rate is analogous to increasing the overall stoichiometry of the fuel cell stack 12 for the purge duration. The flow/volume of purge gas that is released may be minimized by using a similar methods and techniques described above, such as the PWM control of the purge valve and a downstream vessel. It is noted that using the cathode exhaust flow as the primary dilution source may reduce the requirement for secondary dilution.

Many variations are possible and are within the scope of the appended claims. For example, in accordance with other embodiments of the invention, the cathode exhaust may be used as a sole source of dilution. In this regard, the flow of volume of purge gas may be distributed over a period of time (e.g., via PWM control or a downstream vessel), then it is possible that the dilution requirements are low enough such that the cathode exhaust may be sole source. Upon exiting, the product in the remainder of the purge gas rapidly diffuses and dilutes into the ambient.

As another example, if the flow of purge gas out of the anode chamber is so low that no dilution is required, then in accordance with some embodiments of the invention, the primary dilution air source may not be required. Thus, many variations are possible and are within the scope of the appended claims.

As yet another example, a secondary dilution source, such as the secondary dilution air source 320 (FIG. 9), may be used in any of the anode purge subsystems that are described herein for purposes of further diluting the anode purge flow. The secondary dilution source may be a cathode exhaust flow; a flow from an air blower or compressor; etc.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A system comprising:
a fuel cell having an anode chamber in a deadheaded configuration;
a valve connected to the anode chamber, and
a controller to control the valve pursuant to a modulation scheme to purge the anode chamber.

2. The system of claim 1, wherein the modulation scheme comprises a pulse width modulation scheme.

3. The system of claim 1, further comprising:
a flow restrictor connected to the valve to limit a rate at which a flow exits the purge valve.

4. The system of claim 1, further comprising:
a dilution air source connected to dilute a flow that exits the purge valve.

5. The system of claim 1, wherein the controller controls the valve to constant cycles pursuant to a pulse width modulation scheme, each cycle comprising a constant open time in which the purge valve is continuously open and a closed time in which the purge valve is closed.

6. The system of claim 1, further comprising:
a dilution source to dilute a flow provided by the valve.

7. The system of claim 1, further comprising:
a motor vehicle,
wherein the fuel cell, valve and controller are part of the vehicle.

8. A system comprising:
a fuel cell having an anode chamber in a deadheaded configuration; and
a vessel downstream of the anode chamber to temporarily store a purge flow from the anode chamber and provide an exhaust flow to rid the vessel of the stored purge flow,
wherein the purge flow is stored in the vessel at a first rate that is substantially larger than a rate at which the purge flow leaves the vessel.

9. The system of claim 8, further comprising:
a valve; and
a controller to intermittingly open the valve to communicate the purge flow from the anode chamber to the vessel.

10. The system of claim 8, further comprising:
a flow restrictor connected to an outlet of the vessel to limit a rate at which a flow exits the vessel.

11. The system of claim 8, further comprising:
a dilution air source connected to dilute the exhaust flow that exits the vessel.

12. The system of claim 8, further comprising:
a motor vehicle,
wherein the fuel cell and the vessel are part of the vehicle.

13. A system comprising:
a fuel cell having an anode chamber in a deadheaded configuration and adapted to provide a cathode exhaust flow;
a mixer to dilute a purge flow from the anode chamber with the cathode exhaust flow to provide a diluted flow; and
a dilution source to further dilute the diluted flow.

14. The system of claim 13, wherein the dilution source comprises an air source.

15. The system of claim 13, further comprising:
a motor vehicle, wherein the fuel cell, the mixer and the dilution source are part of the vehicle.

16. The system of claim 13, further comprising:
a valve to regulate communication of the purge flow from the anode chamber; and
a controller adapted to:
increase the cathode exhaust flow from a first rate to a higher second rate;
after the increase, cause the valve to open to communicate the purge flow from the anode chamber;
close the valve; and
after closing the valve, return the cathode exhaust flow to the first rate.

17. The system of claim 16, wherein the controller is further adapted to maintain the valve open and maintain the cathode exhaust flow at the second rate until a concentration of fuel is detected below a minimum threshold.

18. The system of claim 13, wherein the controller is further adapted to operate the valve pursuant to a pulse width modulation control scheme.

19. The system of claim 13, further comprising:
a vessel located downstream of the anode chamber to temporarily store the purge flow.

20. A method usable with a fuel cell, comprising:
configuring the fuel cell to be in a deadheaded configuration; and
controlling a valve pursuant to a modulation scheme to purge an anode of the fuel cell.

21. The method of claim 20, wherein the modulation scheme comprises a pulse width modulation scheme.

22. The method of claim 20, further comprising:
using a flow restrictor to limit a rate at which a flow exits the anode.

23. The method of claim 20, further comprising:
providing a dilution source to dilute a flow provided by the valve.

24. A method usable with a fuel cell, comprising:
configuring the fuel cell in a deadheaded configuration;
temporarily storing a purge flow from an anode of the fuel cell;
providing an exhaust flow to remove the storage; and
causing the rate at which the purge flow is stored to be substantially larger than a rate at which the stored purge flow is removed.

25. The method of claim 24, further comprising:
intermittently opening a valve to communicate a purge flow from the anode of the fuel cell.

26. The method of claim 24, further comprising:
limiting a rate at which the purge flow is removed from storage.

27. The method of claim 24, further comprising:
diluting a flow that removes the purge flow from storage.

28. A method usable with a fuel cell, comprising:
configuration the fuel cell in a deadheaded configuration;
diluting a purge flow from anode of the fuel cell with a cathode exhaust flow from the fuel cell; and
further using a source other than the cathode exhaust flow to further dilute the purge flow.

29. The method of claim 28, wherein the act of further using a dilution source comprises using an air source.

30. The method of claim 28, further comprising:
increasing the cathode exhaust flow;
after the increase of the cathode exhaust flow, purging the anode of the fuel cell; and
at the conclusion of the purging of the anode, reducing the cathode exhaust flow.
